(19) United States
(12) Patent Application Publication
(10) Pub. No.: US 2006/0288155 A1
(43) Pub. Date: Dec. 21, 2006

(54) Storage-centric computer system

(75) Inventors: Wayne Thomas Rickard, Irvine, CA (US); Stephen James Sicola, Monument, CO (US); Diana Shen, Colorado Springs, CO (US)

Correspondence Address: Fellers, Snider, Blankenship,;Bailey & Tippens, P.C., Suite 1700, 100 North Broadway, Oklahoma City, OK, 73102-8820, US

(73) Assignee: Seagate Technology LLC

(21) Appl. No.: 11/145,403

(22) Filed: Jun. 3, 2005

(51) Int. Cl. G06F 13/28

(52) U.S. Cl. 711/112

(57) ABSTRACT

A self-contained data storage subsystem is provided for a distributed storage system having a plurality of rotatable spindles, each supporting a storage medium adjacent a respective independently moveable actuator in a data storing and retrieving relationship therewith. A subsystem processor is adapted and integrated with the plurality of spindles, for mapping a virtual storage volume to the plurality of mediums for use by a remote device of the distributed storage system. The combination of the plurality of spindles into a common pool of reliable, provisionable, storage capacity is described. A method to increase the overall reliability, performance, while reducing cost with the combination is also described. By reducing cost, while increasing reliability and performance of the solution, a lower total cost of ownership is realized by users of the intelligent data system.

### FIELD OF THE INVENTION

The claimed invention relates generally to the field of distributed data storage systems and more particularly, but not by way of limitation, to an apparatus and method for autonomous storage-centric control of data services in a storage system.

### BACKGROUND

Computer networking began proliferating when the data transfer rates of industry standard architectures could not keep pace with the data access rate of the 80386 processor made by Intel Corporation. Local area networks (LANs) evolved to storage area networks (SANs) by consolidating the data storage capacity in the network. Users have realized significant benefits by the consolidation of equipment and the associated data handled by the equipment in SANs, such as the capability of handling an order of magnitude more storage than would otherwise be possible with direct attached storage, and doing so at manageable costs.

More recently the movement has been toward a network-centric approach to controlling the data storage subsystems. That is, in the same way that the storage was consolidated, so too are the systems that control the functionality of the storage being offloaded from the servers and into the network itself. Host-based software, for example, can delegate maintenance and management tasks to intelligent switches or to a specialized network storage services platform. Appliance-based solutions eliminate the need for the software running in the hosts, and operate within computers placed as a node in the enterprise. In any event, the intelligent network solutions can centralize such things as storage allocation routines, backup routines, and fault tolerance schemes independently of the hosts.

While moving the intelligence from the hosts to the network resolves some problems such as these, it does not resolve the inherent difficulties associated with the general lack of flexibility in altering the presentation of virtual storage to the hosts. For example, stored data may need to be moved for reliability concerns, or more storage capacity may need to be added to accommodate a growing network. In these events either the host or the network must be modified to make it aware of the existence of the new or changed storage space. What is needed is an intelligent data storage subsystem that self-deterministically allocates, manages, and protects its respective data storage capacity and presents that capacity as a virtual storage space to the network to accommodate global storage requirements. This virtual storage space is able to be provisioned into multiple storage volumes. A distributed computing environment uses these intelligent storage devices for global provisioning as well as for global sparing in the event of failures. It is to this solution that embodiments of the present invention are directed.

### SUMMARY OF THE INVENTION

Embodiments of the present invention are generally directed to a storage-centric subsystem in a distributed storage system with each subsystem autonomously controlling its own data storage and retrieval services.

In some embodiments a self-contained data storage subsystem is provided for a distributed storage system having a plurality of rotatable spindles, each supporting a storage medium adjacent a respective independently moveable actuator in a data storing and retrieving relationship therewith; and a subsystem processor adapted for mapping a virtual storage volume to the plurality of mediums for use by a remote device of the distributed storage system.

In some embodiments a data storage subsystem is provided for a distributed storage system having a self-contained plurality of discrete data storage devices, and a subsystem processor communicating with the data storage devices and adapted for abstracting a command received from a remote device and associating related memory accordingly.

In some embodiments a distributed storage system is provided having a host, and a backend storage subsystem in communication with the host over a network and comprising means for virtualizing a self-contained storage capacity independently of the host.

These and various other features and advantages which characterize the claimed invention will become apparent upon reading the following detailed description and upon reviewing the associated drawings.

### BRIEF DESCRIPTION OF THE DRAWINGS

FIG. 1 is a diagrammatic representation of a computer system in which embodiments of the present invention are useful.

FIG. 2 is a simplified diagrammatic representation of the computer system of FIG. 1.

FIG. 3 is an exploded isometric view of an intelligent data storage subsystem constructed in accordance with embodiments of the present invention.

FIG. 4 is an exploded isometric view of a multiple disc array of the intelligent data storage subsystem of FIG. 3.

FIG. 5 is an exemplary data storage device used in the multiple disc array of FIG. 4.

FIG. 6 is a functional block diagram of the intelligent data storage subsystem of FIG. 3.

FIG. 7 is a functional block diagram of the intelligent storage processor circuit board of the intelligent data storage subsystem of FIG. 3.

FIG. 8 is a functional block diagram of the intelligent storage processor of the intelligent data storage subsystem FIG. 3.

FIG. 9 is a functional block diagram representation of the command abstracting and associated memory mapping services performed by the intelligent data storage subsystem of FIG. 3.

FIG. 10 is a functional block diagram of other exemplary data services performed by the intelligent data storage subsystem of FIG. 3.

FIG. 11 is a view similar to FIG.3 but with the data storage devices and circuit board contained within a sealed enclosure.

### DETAILED DESCRIPTION

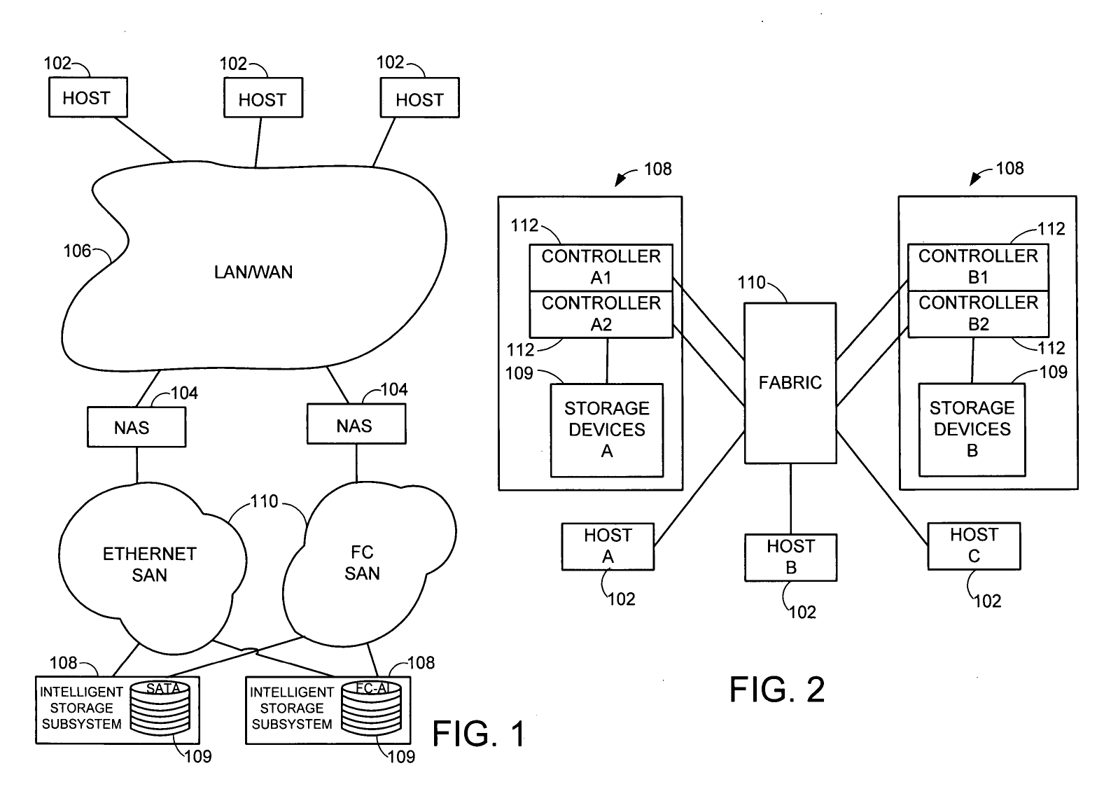

FIG. 1 is an illustrative computer system 100 in which embodiments of the present invention are useful. One or more hosts 102 are networked to one or more network-attached servers 104 via a local area network (LAN) and/or wide area network (WAN) 106. Preferably, the LAN/WAN 106 uses Internet protocol (IP) networking infrastructure for communicating over the World Wide Web. The hosts 102 access applications resident in the servers 104 that routinely need data stored on one or more of a number of intelligent data storage subsystems 108. Accordingly, SANs 110 connect the servers 104 to the intelligent data storage subsystems 108 for access to the stored data. The intelligent data subsystems 108 provide blocks of data storage capacity 109 for storing the data over various selected communication protocols such as serial ATA and fibre-channel, with enterprise or desktop class storage medium within it.

FIG. 2 is a simplified diagrammatic view of the computer system 100 of FIG. 1. The hosts 102 interact with each other as well as with a pair of the intelligent data storage subsystems 108 (denoted A and B, respectively) via the network or fabric 110. Each intelligent data storage subsystem 108 includes dual redundant controllers 112 (denoted A1, A2 and B1, B2) preferably operating on the data storage capacity 109 as a set of data storage devices characterized as a redundant array of independent drives (RAID). The controllers 112 and data storage capacity 109 preferably utilize a fault tolerant arrangement so that the various controllers 112 utilize parallel, redundant links and at least some of the user data stored by the system 100 is stored in redundant format within at least one set of the data storage capacities 109.

It is further contemplated that the A host computer 102 and the A intelligent data storage subsystem 108 can be physically located at a first site, the B host computer 102 and B intelligent data storage subsystem 108 can be physically located at a second site, and the C host computer 102 can be yet at a third site, although such is merely illustrative and not limiting. All entities on the distributed computer system are connected over some type of computer network.

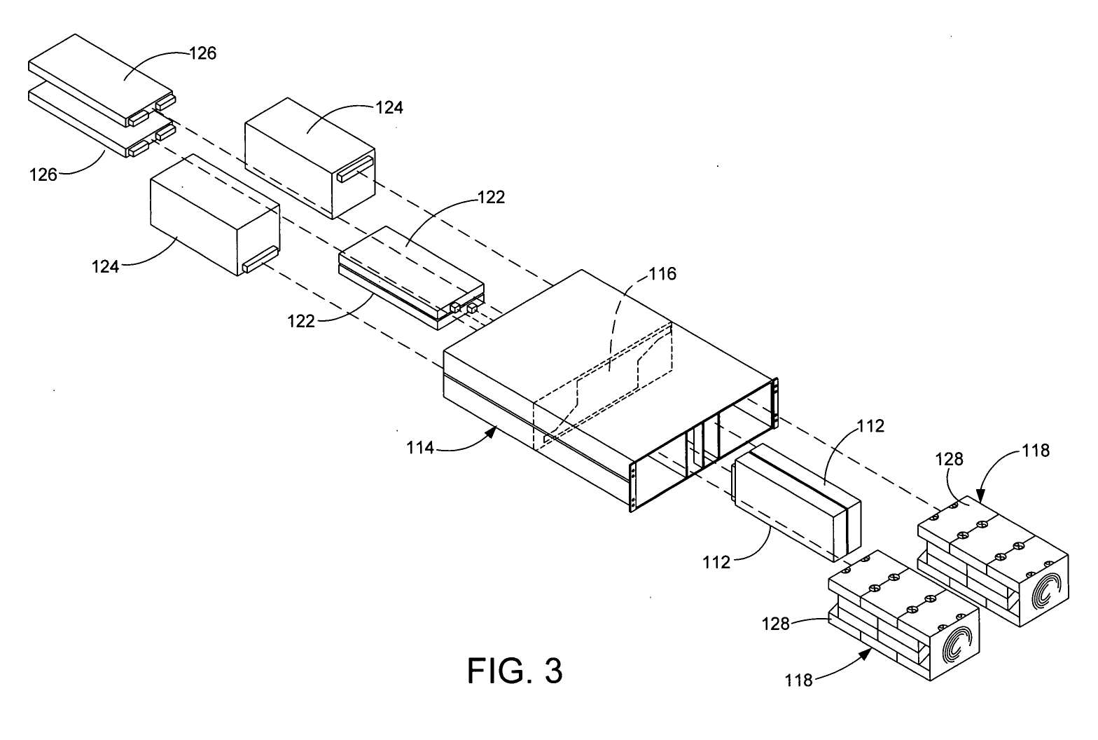

FIG. 3 illustrates an intelligent data storage subsystem 108 constructed in accordance with embodiments of the present invention. A shelf 114 defines cavities for receivingly engaging the controllers 112 in electrical connection with a midplane 116. The shelf is supported, in turn, within a cabinet (not shown). A pair of multiple disc assemblies (MDAs) 118 are receivingly engageable with the shelf 114 on the same side of the midplane 116. Connected to the opposing side of the midplane 116 are dual batteries 122 providing an emergency power supply, dual alternating current power supplies 124, and dual interface modules 126. Preferably, the dual components are configured for operating either of the MDAs 118 or both simultaneously, thereby providing backup protection in the event of a component failure.

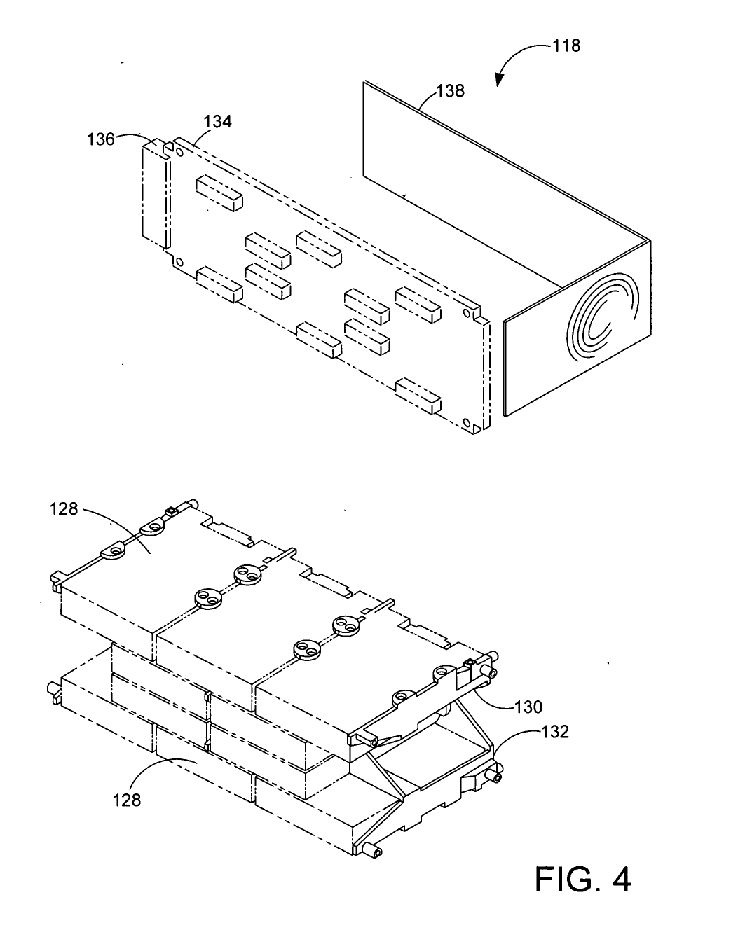

FIG. 4 is an enlarged exploded isometric view of an MDA 118 constructed in accordance with some embodiments of the present invention. The MDA 118 has an upper partition 130 and a lower partition 132, each supporting five data storage devices 128. The partitions 130, 132 align the data storage devices 128 for connection with a common circuit board 134 having a connector 136 that operably engages the midplane 116 (FIG. 3). A wrapper 138 provides electromagnetic interference shielding. This illustrative embodiment of the MDA 118 is the subject matter of patent application Ser. No. 10/884,605 entitled Carrier Device and Method for a Multiple Disc Array which is assigned to the assignee of the present invention and incorporated herein by reference. Another illustrative embodiment of the MDA is the subject matter of patent application Ser. No. 10/817,378 of the same title which is also assigned to the assignee of the present invention and incorporated herein by reference. In alternative equivalent embodiments the MDA 118 can be provided within a sealed enclosure, as discussed below.

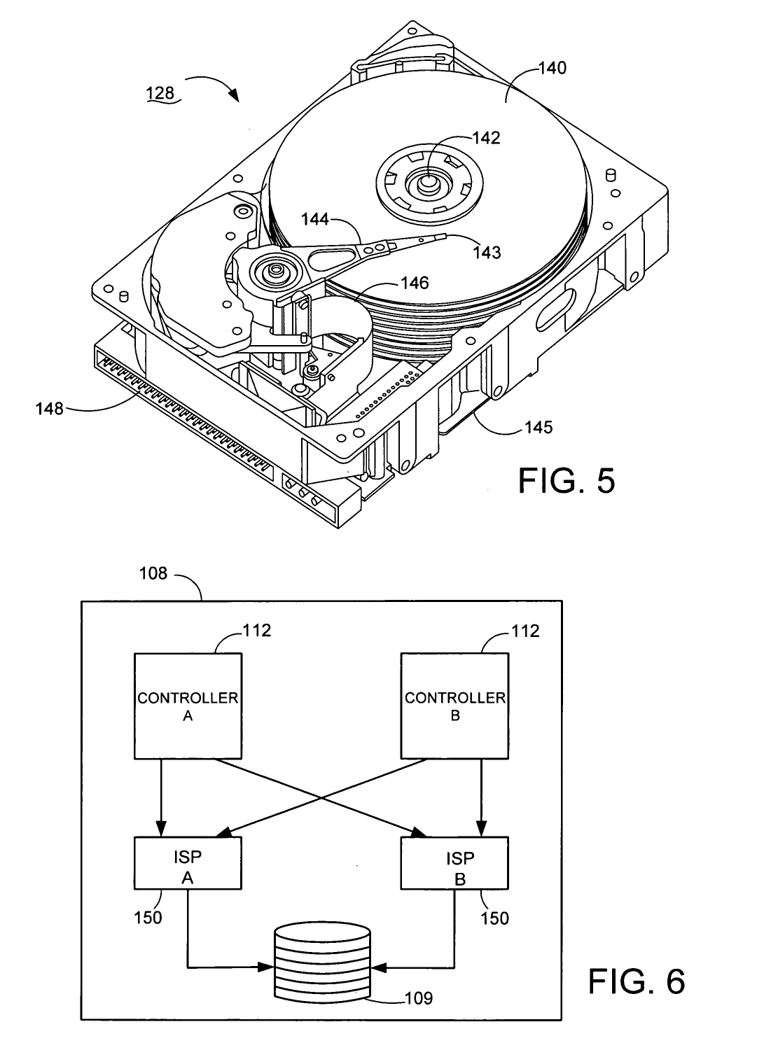

FIG. 5 is an isometric view of an illustrative data storage device 128 suited for use with embodiments of the present invention and in the form of a rotating media disc drive. Although a rotating spindle with moving data storage medium is used for discussion purposes below, in alternative equivalent embodiment a non-rotating medium device, such as a solid state memory device is used. A data storage disc 140 is rotated by a motor 142 to present data storage locations of the disc 140 to a read/write head (“head”) 143. The head 143 is supported at the distal end of a rotary actuator 144 that is capable of moving the head 143 radially between inner and outer tracks of the disc 140. The head 143 is electrically connected to a circuit board 145 by way of a flex circuit 146. The circuit board 145 is adapted to receive and send control signals controlling the functions of the data storage device 128. A connector 148 is electrically connected to the circuit board 145, and is adapted for connecting the data storage device 128 with the circuit board 134 (FIG. 4) of the MDA 118.

FIG. 6 is a diagrammatic view of an intelligent data storage subsystem 108 constructed in accordance with embodiments of the present invention. The controllers 112 operate in conjunction with redundant intelligent storage processors (ISP) 150 to provide managed reliability of the data integrity. The intelligent storage processors 150 can be resident in the controller 112, in the MDA 118, or elsewhere within the intelligent data storage subsystem 108.

Aspects of the managed reliability include invoking reliable data storage formats such as RAID strategies. For example, by providing a system for selectively employing a selected one of a plurality of different RAID formats creates a relatively more robust system for storing data, and permits optimization of firmware algorithms that reduce the complexity of software used to manage the MDA 118 as well as resulting in relatively quicker recovery from storage fault conditions. These and other aspects of this multiple RAID format system is described in patent application Ser. No. 10/817,264 entitled Storage Media Data Structure and Method which is assigned to the present assignee and incorporated herein by reference.

Managed reliability can also include scheduling of diagnostic and correction routines based on a monitored usage of the system. Data recovery operations are executed for copying and reconstructing data. The subsystem processor is integrated with the MDAs 118 in such as way to facilitate “self-healing” of the overall data storage capacity without data loss. These and other aspects of the managed reliability aspects contemplated herein are disclosed in patent application Ser. No. 10/817,617 entitled Managed Reliability Storage System and Method which is assigned to the present assignee and incorporated herein by reference. Other aspects of the managed reliability include responsiveness to predictive failure indications in relation to predetermined rules, as disclosed for example in patent application Ser. No. 11/040,410 entitled Deterministic Preventive Recovery From a Predicted Failure in a Distributed Storage System which is assigned to the present assignee and incorporated herein by reference.

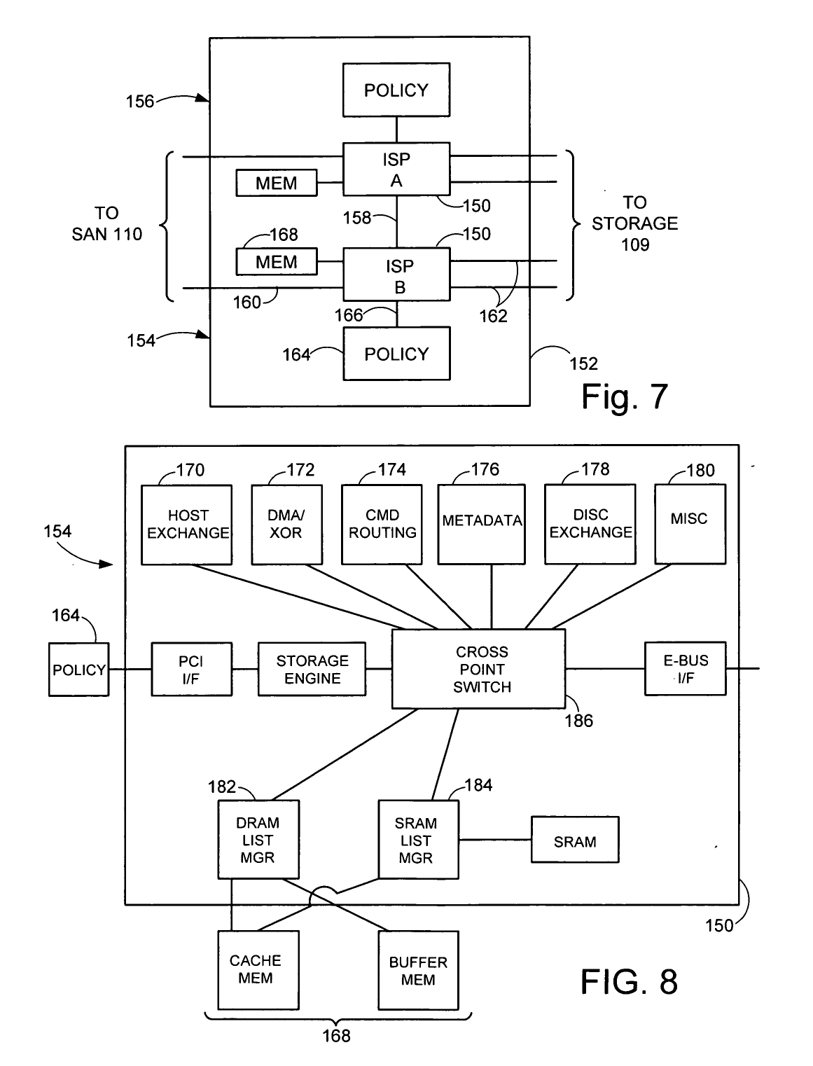

FIG. 7 is a diagrammatic illustration of an intelligent storage processor circuit board 152 in which resides the pair of redundant intelligent storage processors 150. The intelligent storage processor 150 interfaces the data storage capacity 109 to the SAN fabric 110. Each intelligent storage processor 150 can manage assorted storage services such as routing, volume management, and data migration and replication. The intelligent storage processors 150 divide the board 152 into two ISP subsystems 154, 156 coupled by a bus 158. The ISP subsystem 154 includes the ISP 150 denoted “B” which is connected to the fabric 110 and the storage capacity 109 by links 160, 162, respectively. The ISP subsystem 154 also includes a policy processor 164 executing a real-time operating system. The ISP 154 and policy processor 164 communicate over bus 166, and both communicate with memory 168.

FIG. 8 is a diagrammatic view of an illustrative ISP subsystem 154 constructed in accordance with embodiments of the present invention. The ISP 150 includes a number of functional controllers (170-180) in communication with list managers 182, 184 via a cross point switch (CPS) 186 message crossbar. Accordingly, the controllers (170-180) can each generate CPS messages in response to a given condition and send the messages through the CPS to a list manager 182, 184 in order to access a memory module and/or invoke an ISP 150 action. Likewise, responses from a list manager 182, 184 can be communicated to any of the controllers (170-180) via the CPS 186. The arrangement of FIG. 8 and associated discussion are illustrative and not limiting of the contemplated embodiments of the present invention.

The policy processor 164 can be programmed to execute desired operations via the ISP 150. For example, the policy processor 164 can communicate with the list managers 182, 184, that is send and receive messages, via the CPS 186. Responses to the policy processor 164 can serve as interrupts signaling the reading of memory 168 registers.

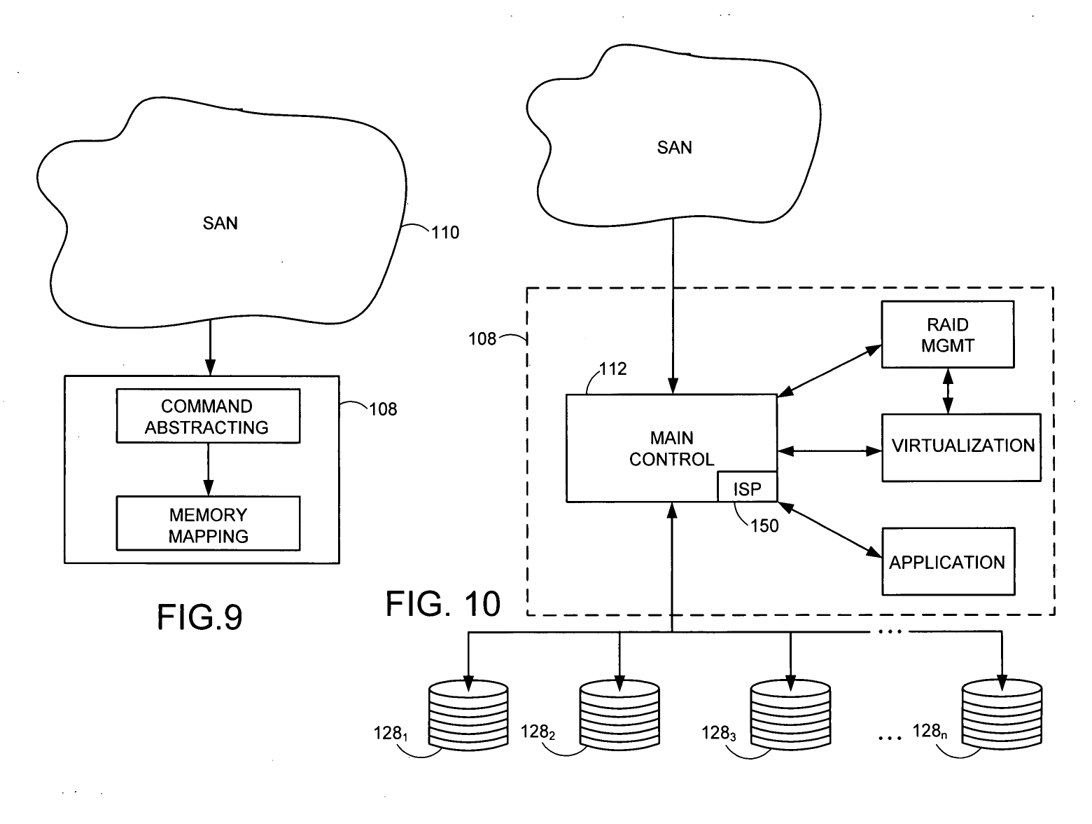

FIG. 9 is a diagrammatic illustration of the flexibility advantages of the intelligent data storage subsystem 108, by way of the intelligent controllers 112, to communicate with a host 102 in any of a preselected plurality of communication protocols, such as FC, iSCSI, or SAS. The intelligent data storage subsystem 108 can be programmed to ascertain the abstraction level of a host command, and to map a virtual storage volume to the physical storage 109 associated with the command accordingly.

For present purposes, the term “virtual storage volume” means a logical entity that generally corresponds to a logical abstraction of physical storage. “Virtual storage volume” can include, for example, an entity that is treated (logically) as though it was consecutively addressed blocks in a fixed block architecture or records in a count-key-data architecture. A virtual storage volume can be physically located on more than one storage element.

FIG. 10 is a diagrammatic illustration of types of data management services that can be conducted by the intelligent data storage subsystem 108 independently of any host 102. For example, RAID management can be locally controlled for fault tolerant data integrity sake, with striping of data performed within a desired number of the data storage devices 128₁, 128₂, 128₃ . . . 128ₙ. Virtualization services can be locally controlled to allocate and/or deallocate memory capacity to logical entities. Application routines, such as the managed reliability schemes discussed above, can likewise be controlled locally.

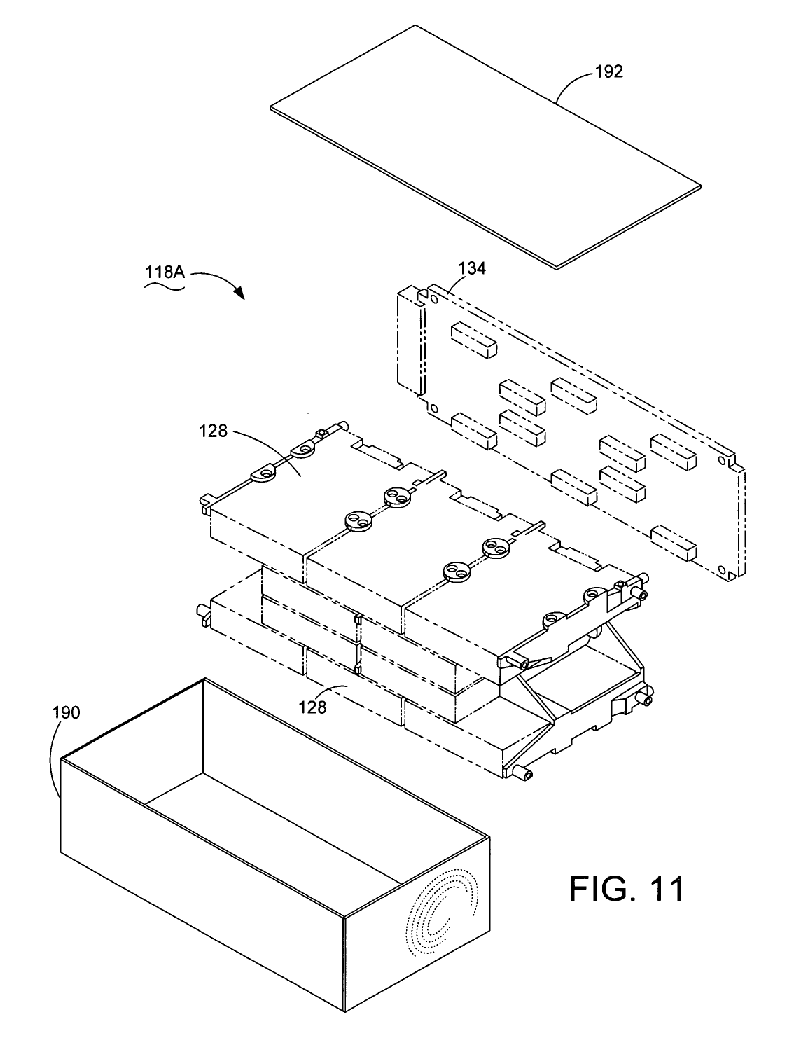

Finally, FIG. 11 is a view similar to FIG. 4 but with the plurality of data storage devices 128 and circuit board 134 contained within a sealed enclosure made from a base 190 with a cover 192 sealingly attached thereto. Sealingly engaging the data storage devices 128 forming the MDA 118A provides numerous advantages to the user including guaranteeing the arrangement of the data storage devices 128 is not altered from a preselected optimal arrangement. Such an arrangement also permits the MDA 118A manufacturer to tune the system for optimal performance, given the number, size, and type of data storage devices 128 can be clearly defined.

The sealed MDA 118A also allows the manufacturer to maximize the reliability and fault tolerance of the group of storage medium within. This is done by optimizing the drives in the multi-spindle arrangement. Design Optimizations are allowed within to reduce cost, increase performance, increase reliability, all toward the extended life of the data within the MDA 118A. The MDA 118A is itself a basis for further refinement of the abstract protected storage container. Furthermore, the design of the MDA 118 itself provides an almost zero rotational vibration and high cooling efficiency environment. This allows the storage medium within to be manufactured to less costly standards without compromising the MDA 118 reliability, performance, or capacity. The sealed MDA 118A thus provides no single point of failure and near perfect rotational vibration avoidance and cooling efficiency. This allows designing the MDA 118A for optimal disc medium characteristics, and reduces cost while at the same time increasing reliability and performance.

In summary, a self-contained data storage subsystem (such as 108) for a distributed storage system (such as 100) is provided, including a plurality of rotatable spindles (such as 142) each supporting a storage medium (such as 140) adjacent a respective independently moveable actuator (such as 143) in a data storing and retrieving relationship with the storage medium. The data storage subsystem further includes a subsystem processor (such as 150) adapted for mapping a virtual storage volume to the plurality of mediums for use by a remote device (such as 102) of the distributed storage system.

In some embodiments the subsystem has the plurality of spindles and mediums contained within a common sealed housing (such as 190, 192). Preferably, the subsystem processor allocates memory in the virtual storage volume for storing data in a fault tolerant manner, such as in a RAID methodology. The processor is furthermore capable of performing managed reliability methodologies in the data storage process, such as initiating in-situ deterministic preventive recovery steps in response to an observed predicted storage failure. Preferably, the data storage subsystem is made of a plurality of data storage devices (such as 128) each having a disc stack made of two of more discs of data storage medium.

In other embodiments data storage subsystem is contemplated for a distributed storage system comprising a self-contained plurality of discrete data storage devices and a subsystem processor communicating with the data storage devices and adapted for abstracting a command (such as in FIG. 9) received from a remote device and associating related memory accordingly. Preferably, the subsystem processor is adapted for mapping a virtual storage volume to the plurality of data storage devices for use by one or more remote devices of the distributed storage system. As before, the plurality of data storage devices and mediums can be contained within a common sealed housing. Preferably, the subsystem processor allocates memory in the virtual storage volume for storing data in a fault tolerant manner, such as in a RAID methodology. The subsystem processor can furthermore initiate in-situ deterministic preventive recovery steps in the data storage devices in response to an observed predicted storage failure.

In alternative embodiments a distributed storage system is provided comprising a host; and a backend storage subsystem in communication with the host over a network and comprising means for virtualizing a self-contained storage capacity independently of the host.

The means for virtualizing can be characterized by a plurality of discrete individually accessible data storage units. The means for virtualizing can be characterized by mapping a virtual block of storage capacity associated with the plurality of data storage units. The means for virtualizing can be characterized by sealingly containerizing the plurality of data storage units and associated controls. The means for virtualizing can be characterized by storing data in a fault tolerant manner, such as without limitation to RAID methodology. The means for virtualizing can be characterized by initiating in-situ deterministic preventive recovery steps in response to an observed predicted storage failure. The means for virtualizing can be characterized by a multiple spindle data storage array.

For purposes herein the term “means for virtualizing” expressly does not contemplate previously attempted solutions that included the system intelligence for mapping the data storage space anywhere but within the respective data storage subsystem. For example, “means for virtualizing” does not contemplate the use of a storage manager to control the functions of data storage subsystems; neither does it contemplate the placement of the manager or switch within the SAN fabric, or within the host.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed. For example, the particular elements may vary depending on the particular processing environment without departing from the spirit and scope of the present invention.

In addition, although the embodiments described herein are directed to a data storage array, it will be appreciated by those skilled in the art that the claimed subject matter is not so limited and various other processing systems can be utilized without departing from the spirit and scope of the claimed invention.

What is claimed is:

1. A self-contained data storage subsystem for a distributed storage system comprising:
a plurality of rotatable spindles each supporting a storage medium adjacent a respective independently moveable actuator in a data storing and retrieving relationship therewith; and
a subsystem processor adapted for mapping and managing virtual storage volumes to the plurality of mediums for use by a remote device of the distributed storage system.

2. The subsystem of claim 1 wherein the plurality of spindles and mediums are contained within a common sealed housing.

3. The subsystem of claim 1 wherein the subsystem processor allocates memory in the virtual storage volume for storing data in a fault tolerant manner.

4. The subsystem of claim 3 wherein the subsystem processor stores data in a selected one of a plurality of different redundant array of independent drive (RAID) methodologies.

5. The subsystem of claim 1 wherein the subsystem processor is adapted for self-initiating in-situ deterministic preventive recovery steps as well as in response to an observed storage failure.

6. The subsystem of claim 1 wherein the data storage subsystem comprises a plurality of mediums on one spindle.

7. A data storage subsystem for a distributed storage system comprising a self-contained plurality of discrete data storage devices and a subsystem processor communicating with the data storage devices and adapted for abstracting a command received from a remote device and associating related memory accordingly.

8. The subsystem of claim 7 wherein the subsystem processor is adapted for mapping a virtual storage volume to the plurality of data storage devices for use by one or more remote devices of the distributed storage system.

9. The subsystem of claim 7 wherein the plurality of data storage devices and mediums are contained within a common sealed housing, having no single point of failure and near perfect rotational vibration avoidance and cooling efficiency.

10. The subsystem of claim 7 wherein the subsystem processor allocates memory in the virtual storage volume for storing data in a fault tolerant manner.

11. The subsystem of claim 10 wherein the subsystem processor stores data in a redundant array of independent drive (RAID) methodology.

12. The subsystem of claim 7 wherein the subsystem processor initiates in-situ deterministic preventive recovery steps in the data storage devices as well as in response to an observed storage failure.

13. A distributed storage system comprising:
a host; and
a backend storage subsystem in communication with the host over a network and comprising means for virtualizing a self-contained storage capacity independently of the host.

14. The system of claim 13 wherein the means for virtualizing is characterized by a plurality of discrete individually accessible data storage units.

15. The system of claim 14 wherein the means for virtualizing is characterized by mapping a virtual block of storage capacity associated with the plurality of data storage units.

16. The system of claim 14 wherein the means for virtualizing is characterized by sealingly containerizing the plurality of data storage units and associated controls.

17. The system of claim 13 wherein the means for virtualizing is characterized by storing data in a fault tolerant manner.

18. The system of claim 13 wherein the means for virtualizing is characterized by storing data in a redundant array of independent drive (RAID) methodology.

19. The system of claim 13 wherein the means for virtualizing is characterized by initiating in-situ deterministic preventive recovery steps as well as in response to an observed storage failure.

20. The system of claim 13 wherein the means for virtualizing is characterized by data storage comprising either a moving data storage medium or a non-moving data storage medium or both.
